(19) United States
(12) Patent Application Publication
(10) Pub. No.: US 2015/0317510 A1
(43) Pub. Date: Nov. 5, 2015

(54) RATING PHOTOS FOR TASKS BASED ON CONTENT AND ADJACENT SIGNALS

(71) Applicant: MICROSOFT CORPORATION, Redmond, WA (US)

(72) Inventors: David Lee, Redmond, WA (US); Chunkit Jacky Chan, Redmond, WA (US); Doug Ricard, Woodinville, WA (US); Stacia Scott, Bellingham, WA (US); Allison Light, Seattle, WA (US); William David Sproule, Woodinville, WA (US); Meghan McNeil, Seattle, WA (US); Christopher Mabrey, Seattle, WA (US); Adam Avery, Bellevue, WA (US); Joshua Weisberg, Redmond, WA (US); Alexander Brodie, Redmond, WA (US)

(73) Assignee: MICROSOFT CORPORATION, Redmond, WA (US)

(21) Appl. No.: 14/266,795

(22) Filed: Apr. 30, 2014

(51) Int. Cl. G06K 9/00; G06K 9/62

(52) U.S. Cl. CPC G06K 9/00228; G06K 9/6218

(57) ABSTRACT

Technologies for selecting a representative subset of images from a set of images, the selecting based at least in part on rating the images in the set based on task, Image, and/or adjacent information. An Indication of the task may be embodied in a query provided by a user. The task may indicate the user's intended use of the subset of images. The set of images may be grouped into one or more clusters that are based on technical attributes of the images in the set, and/or technical attributes indicated by the task. Adjacent information may be obtained from sources that are generally unrelated or indirectly related to the images in the set. Technical attributes such as face quality, face frequency, and relationship are based on facial recognition functionality that detects faces and their features in an image, and that calculates information such as a face signature that, across the images in the set, uniquely identifies an entity that the face represents, and that determines facial expressions such as smiling, sad, and neutral.

### BACKGROUND

Thanks to advances in imaging technologies, people take more pictures than ever before. Further, the proliferation of media sharing applications has increased the demand for picture sharing to a greater degree than ever before. Yet the flood of photos, and the need to sort through them to find relevant pictures, has actually increased the time and effort required for sharing pictures. As a result, it is often the case that either pictures that are less than representative of the best pictures, or no pictures at all, end up getting shared.

### SUMMARY

The summary provided in this section summarizes one or more partial or complete example embodiments of the invention in order to provide a basic high-level understanding to the reader. This summary is not an extensive description of the invention and it may not identify key elements or aspects of the invention, or delineate the scope of the invention. Its sole purpose is to present various aspects of the invention in a simplified form as a prelude to the detailed description provided below.

The invention encompasses technologies for selecting a representative subset of images from a set of images, the selecting based at least in part on rating the images in the set based on task, image, and/or adjacent information. An indication of the task may be embodied in a query provided by a user. The task may indicate the user's intended use of the subset of images. The set of images may be grouped into one or more clusters that are based on technical attributes of the images in the set, and/or technical attributes indicated by the task. Adjacent information may be obtained from sources that are generally unrelated or indirectly related to the images in the set. Technical attributes such as face quality, face frequency, and relationship are based on facial recognition functionality that detects faces and their features in an image, and that calculates information such as a face signature that, across the images in the set, uniquely identifies an entity that the face represents, and that determines facial expressions such as smiling, sad, and neutral.

Many of the attendant features will be more readily appreciated as the same become better understood by reference to the detailed description provided below in connection with the accompanying drawings.

### DESCRIPTION OF THE DRAWINGS

The detailed description provided below will be better understood when considered in connection with the accompanying drawings, where:

FIG. 1 is a block diagram showing an example computing environment in which the invention may be implemented.

FIG. 2 is a block diagram showing an example system configured for selecting a representative subset of images from a set of images, the selecting based at least in part on rating the images in the set based on task, image, and/or adjacent information.

FIG. 3 is a block diagram showing various example classes of technical attributes.

FIG. 4 is a block diagram showing an example method for selecting a representative subset of images from a set of images.

Like-numbered labels in different figures are used to designate similar or identical elements or steps in the accompanying drawings.

### DETAILED DESCRIPTION

The detailed description provided in this section, in connection with the accompanying drawings, describes one or more partial or complete example embodiments of the invention, but is not intended to describe all possible embodiments of the invention. This detailed description sets forth various examples of at least some of the technologies, systems, and/or methods invention. However, the same or equivalent technologies, systems, and/or methods may be realized according to examples as well.

Although the examples provided herein are described and illustrated as being implementable in a computing environment, the environment described is provided only as an example and not a limitation. As those skilled in the art will appreciate, the examples disclosed are suitable for implementation in a wide variety of different computing environments.

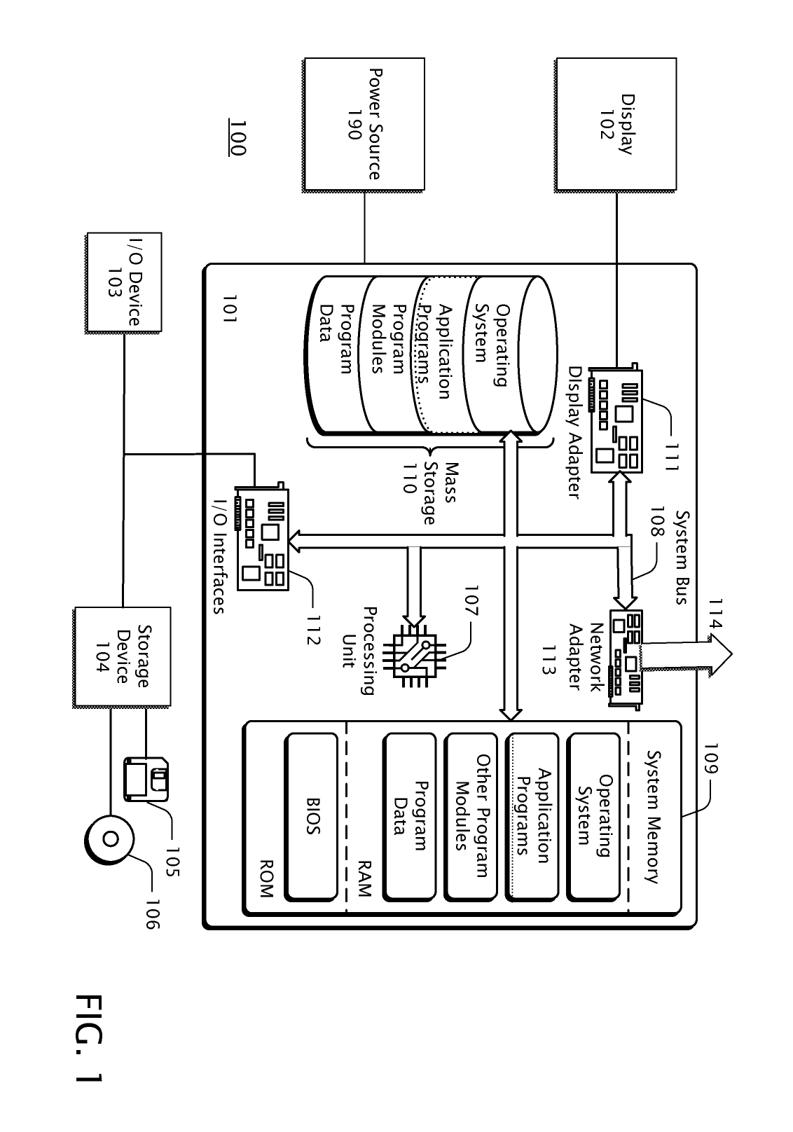

FIG. 1 is a block diagram showing an example computing environment 100 in which the invention described herein may be implemented. A suitable computing environment may be implemented with numerous general purpose or special purpose systems. Examples of well known systems include, but are not limited to, cell phones, personal digital assistants (“PDA”), personal computers (“PC”), hand-held or laptop devices, microprocessor-based systems, multiprocessor systems, systems on a chip (“SOC”), servers, Internet services, workstations, consumer electronic devices, cell phones, set-top boxes, and the like. In all cases, such systems are strictly limited to articles of manufacture and the like.

Computing environment 100 typically includes a general-purpose computing system in the form of a computing device 101 coupled to various components, such as peripheral devices 102, 103, 101 and the like. These may include components such as input devices 103, including voice recognition technologies, touch pads, buttons, keyboards and/or pointing devices, such as a mouse or trackball, that may operate via one or more input/output (“I/O”) interfaces 112. The components of computing device 101 may include one or more processors (including central processing units (“CPU”), graphics processing units (“GPU”), microprocessors (“μP”), and the like) 107, system memory 109, and a system bus 108 that typically couples the various components. Processor(s) 107 typically processes or executes various computer-executable instructions and, based on those instructions, controls the operation of computing device 101. This may include the computing device 101 communicating with other electronic and/or computing devices, systems or environments (not shown) via various communications technologies such as a network connection 114 or the like. System bus 108 represents any number of bus structures, including a memory bus or memory controller, a peripheral bus, a serial bus, an accelerated graphics port, a processor or local bus using any of a variety of bus architectures, and the like.

System memory 109 may include computer-readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 109 typically stores data, computer-executable instructions and/or program modules comprising computer-executable instructions that are immediately accessible to and/or presently operated on by one or more of the processors 107.

Mass storage devices 104 and 110 may be coupled to computing device 101 or incorporated into computing device 101 via coupling to the system bus. Such mass storage devices 104 and 110 may include non-volatile RAM, a magnetic disk drive which reads from and/or writes to a removable, non-volatile magnetic disk (e.g., a “floppy disk”) 105, and/or an optical disk drive that reads from and/or writes to a non-volatile optical disk such as a CD ROM, DVD ROM 106. Alternatively, a mass storage device, such as hard disk 110, may include non-removable storage medium. Other mass storage devices may include memory cards, memory sticks, tape storage devices, and the like.

Any number of computer programs, files, data structures, and the like may be stored in mass storage 110, other storage devices 104, 105, 106 and system memory 109 (typically limited by available space) including, by way of example and not limitation, operating systems, application programs, data files, directory structures, computer-executable Instructions, and the like.

Output components or devices, such as display device 102, may be coupled to computing device 101, typically via an interface such as a display adapter 111. Output device 102 may be a liquid crystal display (“LCD”). Other example output devices may include printers, audio outputs, voice outputs, cathode ray tube (“CRT”) displays, tactile devices or other sensory output mechanisms, or the like. Output devices may enable computing device 101 to interact with human operators or other machines, systems, computing environments, or the like. A user may interface with computing environment 100 via any number of different I/O devices 103 such as a touch pad, buttons, keyboard, mouse, Joystick, game pad, data port, and the like. These and other I/O devices may be coupled to processor 107 via I/O interfaces 112 which may be coupled to system bus 108, and/or may be coupled by other interfaces and bus structures, such as a parallel port, game port, universal serial bus (“USB”), fire wire, infrared (“IR”) port, and the like.

Computing device 101 may operate in a networked environment via communications connections to one or more remote computing devices through one or more cellular networks, wireless networks, local area networks (“LAN”), wide area networks (“WAN”), storage area networks (“SAN”), the Internet, radio links, optical links and the like. Computing device 101 may be coupled to a network via network adapter 113 or the like, or, alternatively, via a modem, digital subscriber line (“DSL”) link, integrated services digital network (“ISDN”) link, Internet link, wireless link, or the like.

Communications connection 114, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Power source 190, such as a battery or a power supply, typically provides power for portions or all of computing environment 100. In the case of the computing environment 100 being a mobile device or portable device or the like, power source 190 may be a battery. Alternatively, in the case computing environment 100 is a desktop computer or server or the like, power source 190 may be a power supply designed to connect to an alternating current (“AC”) source, such as via a wall outlet.

Some mobile devices may not include many of the components described in connection with FIG. 1. For example, an electronic badge may be comprised of a coil of wire along with a simple processing unit 107 or the like, the coil configured to act as power source 190 when in proximity to a card reader device or the like. Such a coil may also be configure to act as an antenna coupled to the processing unit 107 or the like, the coil antenna capable of providing a form of communication between the electronic badge and the card reader device. Such communication may not involve networking, but may alternatively be general or special purpose communications via telemetry, point-to-point, RF, IR, audio, or other means. An electronic card may not include display 102, I/O device 103, or many of the other components described in connection with FIG. 1. Other mobile devices that may not include many of the components described in connection with FIG. 1, by way of example and not limitation, include electronic bracelets, electronic tags, implantable devices, and the like.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code, data, applications, programs, program modules, or the like maintained in an electronic device such as a ROM. The term “software” generally refers to computer-executable instructions, code, data, applications, programs, program modules, or the like maintained in or on any form or type of computer-readable media that is configured for storing computer-executable instructions or the like in a manner that is accessible to a computing device. The term “computer-readable media” and the like as used herein is strictly limited to one or more apparatus, article of manufacture, or the like that is not a signal or carrier wave per se. The term “computing device” as used in the claims refers to one or more devices such as computing device 101 and encompasses client devices, mobile devices, one or more servers, network services such as an Internet service or corporate network service, and the like, and any combination of such.

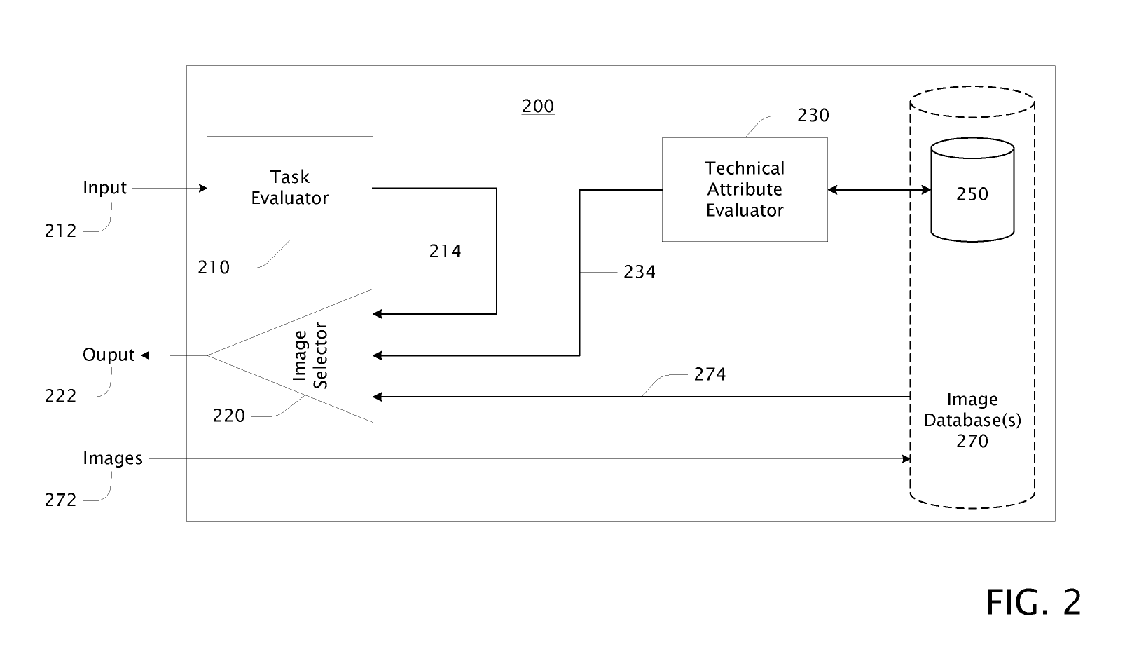

FIG. 2 is a block diagram showing an example system 200 configured for selecting a representative subset of images from a set of images, the selecting based at least in part on rating the images in the set based on task, image, and/or adjacent information. The system includes several modules including task evaluator 210 that accepts input 212, technical attribute evaluator 230, image database(s) 270 that accepts at least image inputs 272 and that may include technical attribute portion 250 (alternatively, this portion may be separate from image database(s) 270), and Image selector 220 that produces output 222. Each of these modules may be implemented in hardware, firmware, software (e.g., program modules comprising computer-executable instructions), or any combination thereof. Each such module may be implemented on/by one device, such as a computing device, or across multiple such devices. For example, one module may be implemented in a distributed fashion on/by multiple devices such as servers or elements of a network service or the like. Further, each such module may encompass one or more sub-modules or the like, and the modules may be implemented as separate modules, or any two or more may be combined in whole or in part. The division of modules described herein in non-limiting and intended primarily to aid in describing aspects of the invention.

In summary, system 200 is configured for selecting a representative subset of images from a set of images based on a particular task being performed, such as a task being performed by a user, and further based on technical attributes of the images in the set. Such a user may be a person or another system of any type.

The term “representative subset of images” as used herein means at least a portion of the images from the set that best represents the set of images in view of the user task and the technical attributes and representative attributes of the images. The representative subset of images is typically provided as output 222 of the system. The set of images is typically provided by one or more sources as input 272 to the system. Such sources include camera phones, digital cameras, digital video recorders (“DVRs”), computers, digital photo albums, social media applications, image and video streaming web sites, and any other source of digital images. Note that actual images may be input and/or output, or references to images, or any combination of such.

The user task may be as simple as a user requesting a portion or desired number of images from the subset. Alternatively, the user task may be an indication of a intended use of the subset by the user, such as a presenting the images in the subset in a slide show or the like, sharing the images in the subset by posting them on a social media site, creating a photo album, or any other task or activity the user may be performing or intend to perform that involves selecting a representative subset of the images in the set.

The representative subset of images is typically selected from the set of images. But in some examples, images from outside the set of images may also be included in the selection process. In one example, the user may have access to external images that are not part of the set, such as on a computer or a social media site or the like. In some cases such external images may also be included in the selection process. The term “external image” as used herein refers to images that are not part of the set of images provided as input 272, but are instead from one or more external image sources. Further, the term “images from the set” may include one or more external images from one or more external image sources as well. In another example, the term “images from the set” may indicate images taken strictly from external image sources, from additional or alternative sets of images, or from any combination thereof. The term “image” as used herein typically refers to a digital image such as a digital photograph, a digitized photograph, document, or the like, a frame from a digital or digitized video, or the like.

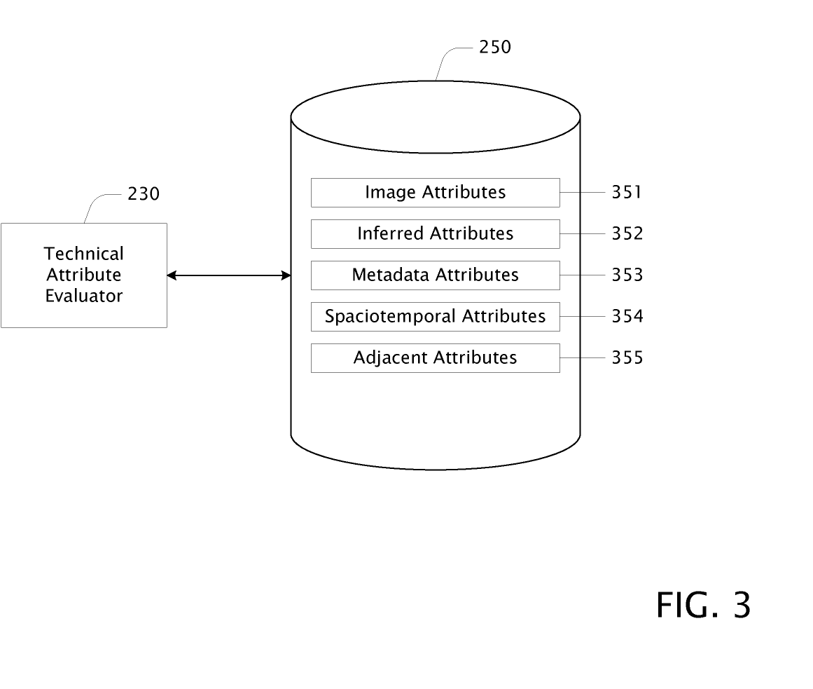

The term “technical attributes” as used herein typically refers to several classes of attributes of an image, that can be inferred from the image, that are associated with the image, that may correspond to the image, etc. Such attributes are described in connection with FIG. 3.

Task evaluator 210 is a module that evaluates input 212 that describes a task or an intention of a user, such as the purpose for requesting a representative subset of images from the set of images 272 from the system 200. In one example, input 212 may simply indicate a request for a portion of the images that are representative of the set of images 272. In another example, input 212 may simply indicate a desired number of images that are representative of the set of images 272. In other examples, input 212 may indicate an intended use for a representative subset of images from a set of images. The term “intended use” as used herein refers to what the user is doing or intends to do with the representative subset of images. Examples of such intended uses include presenting the images in the subset in a slide show or the like, sharing the images in the subset by posting them on a social media site, creating a photo album, simply viewing the images, printing the images, etc.

Task evaluator 210 provides an output 214 to image selector 220 that represents input 212. This output 214 may indicate to image selector a size for the requested the representative subset of images 222, a degree of diversity for the requested the representative subset of images 222, a theme(s) for the requested the representative subset of images 222, etc.

Technical attribute evaluator 230 is a module that evaluates technical attributes of an image, that can be inferred from the image, that are associated with the image, that may correspond to the image, etc., such as described in connection with FIG. 3. Such technical attributes (one or more) may be evaluated for each image in the set of images. Each technical attribute may be weighted. Each technical attribute, or a reference to it, may be obtained from database 250, or may be derived from image metadata, from the image itself, from one or more other technical attributes, and/or from other sources. At least a portion of the results of evaluation may be stored in database 250, and may also or alternatively be provided to image selector 220 via output 234. Technical attribute weights may also be obtained from database 250, be determined as part of the evaluation, be provided by a user, and/or be incorporated by system 200 and default values. Technical attribute weights may be further configurable by a user and/or be adjusted over time based on training or learning algorithms or the like.

One output of technical attribute evaluator 230 is an image quality score for each image evaluated. Each image quality score is typically based at least on a portion of the technical attributes of the image being evaluated. Once determined, image quality scores may be stored in database 250. Image quality scores may be determined at the time images are input 272 to the system 200, or at any other time. Once determined, the image quality scores may be saved, such as in database 250, and may not need to be determined again. Further, one or more determined image quality scores may be combined with additional image technical attributes or other information to determine a new or updated image quality score.

Image database(s) 270 is a module that may be a part of system 200 or may be separate from system 200, and may store images provided as input 272 to the system 200. Image database(s) 270 may include one or more existing image repositories, video streams, Web-hosted image stores, digital photo albums, or the like. Such database(s) 270 may be maintained as part of system 200, social media web sites, user albums or stores, etc. Such database(s) 270 may store actual images, references to images, or any combination of the like. Thus, the term “stored” as used herein encompasses data being stored as well as a reference(s) to the data being stored instead of or in addition to the actual data itself.

Technical attribute portion 250 is a module may be a portion of image database(s) 270 or may be a separate store or both. Portion 250 may store technical attributes of images as well as their weights.

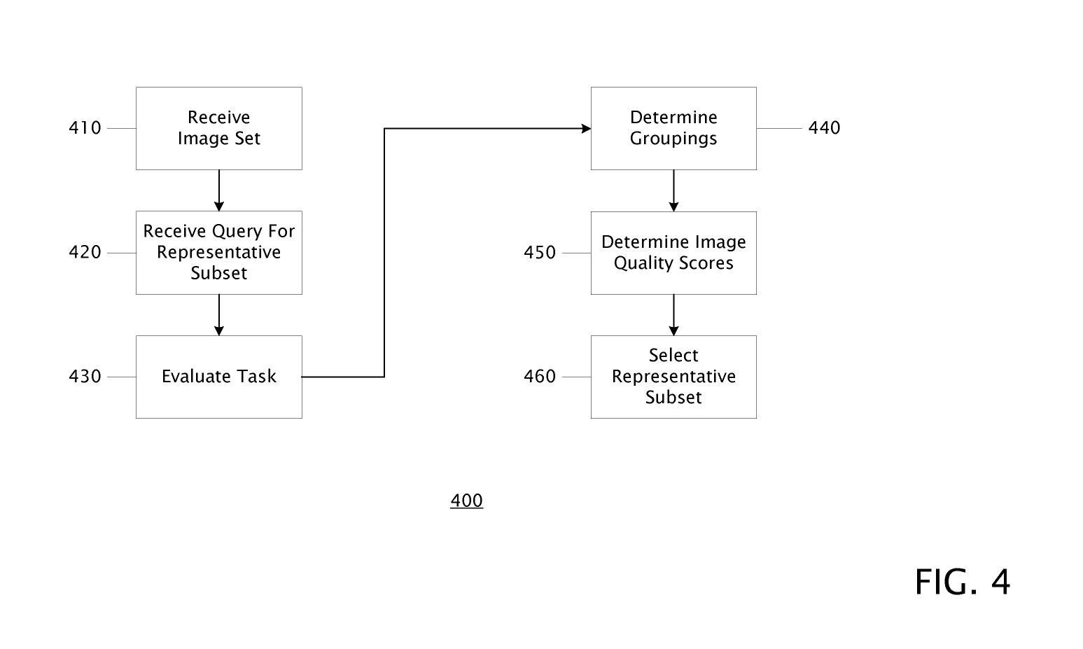

Image selector 220 is a module that selects a representative subset of images 222 from the input set of images 272 based on provided task information 212 and the technical attributes of the input set of images 272. One example of a selecting process performed by image selector 220 is described in connection with FIG. 4. Results of the selecting process are provided as a representative subset of images via output 222 that is based at least in part on one or more of the evaluated task information 214 provided by task evaluator 210, evaluated technical attributes 234 including image quality scores provided by technical attribute evaluator 230, and information from image database(s) 270. Output 222 may be in the form of the actual selected images, references to selected images, or any combination of the like.

FIG. 3 is a block diagram showing various example classes of technical attributes. Image attributes 351 is a class of technical attributes that typically indicate technical aspects of an image, such as (but not limited to):
Exposure—generally referring to a single shutter cycle; may be defined as the amount of light per unit area (the image plane illuminance times the exposure time) reaching a photographic film, as determined by shutter speed, lens aperture and scene luminance or the equivalents. In digital photography “film” is substituted with “sensor”. An image may suffer from over-exposure or under-exposure, thus reducing the quality of the image.
Sharpness—generally referring to the degree to which an image is in focus; may be defined as the degree of visual clarity of detail in an image; largely a function of resolution and acutance.
Hue variety—generally referring to the degree to which color information in an image is visually appealing;
Saturation—generally refers to the degree to which a color in an image appears “washed out”, the less saturated the less vivid (strong) and more washed-out the color appears while the more saturated the more vivid (strong) and less washed-out the color appears; may be defined as the strength (vividness) of a color in an image;
Contrast—generally referring to the degree of differentiation between dark and bright image portions, increased contrast generally makes different elements in an image more distinguishable while decreased contrast generally makes the different elements less distinguishable; may be defined as the degree of difference in luminance and/or color between elements.
Alignment—generally referring to the tilt of an image; may be defined as the degree of rotation of the image from level or the horizontal plane of the image.
Noise—generally referring to the degree of noise in an image; may be defined as random variations in brightness and color that are not present in the original scene.
Deagree of Autofix Tuning—generally referring to a degree to which an image has been tuned or changed, such as by a conventional Autofix program or the like, may be or include a degree to which the image was not able to be fixed by the program, or a degree to which the image is still defective even after Autofix;
Dominant colors—generally refers to an indication of the dominant colors categories in an image, where a green color category, for example, includes various tints and shades of green, a brown color category includes various shades and tints of brown, and the like for other colors categories such as red, blue, and other primary, secondary, and/or tertiary colors, including back and white, or other desirable color categories.
Composition—generally refers to a degree of conformance by an image to the conventional “rule of thirds”;
Face quality—generally refers to a degree of quality of any faces in an image; a higher face quality of an image tends to have characteristics including eyes open and in focus, eyes directed to the camera or to a subject of the image, faces with smiles, and visually appealing faces; An image's face quality may also be based on face sizes relative to each other and relative to the size of the image.

Inferred attributes 352 is a class of technical attributes that typically indicate whether an image is likely of interest based on any people (or faces) in the image, such as (but not limited to):
Face frequency—generally referring to the frequency that a face in an image also appears in the other images of a set of images; a higher face frequency for a dominant face in an image generally indicates that the face, and thus the image, is more important relative to images without the face or in which the face is less dominant.
Relationship—generally refers to an indication of a relationship between a user of system 200 or some other specified person(s) and a person(s) whose face is identified in an image. An image with an indication of such a relationship(s) is generally considered to be more important than images without such indications.

Metadata attributes 353 is a class of technical attributes that typically indicate metadata associated with the image. Such image metadata may be included with an image (e.g., recorded in the image file) or otherwise associated with the image. Such image metadata may include exchangeable image file format (“EXIF”) information, international press telecommunications council (“IPTC”) metadata, extensible metadata platform (“XMP”) metadata, and/or other standards-based or proprietary groupings, sources, or formats of image metadata, and include image metadata such as (but not limited to):
Focal Length—generally indicates the focal length of a camera at the time of image capture.
Shutter Speed—generally indicates the shutter speed setting of a camera at the time of image capture.
Film Speed—generally indicates the ISO setting of a camera at the time of image capture.
Aperture—generally indicates the aperture setting of a camera at the time of image capture.
Camera Orientation—generally indicates the physical orientation of a camera at the time of image capture.
Camera Motion—generally indicates characteristics of any physical motion of a camera at the time of image capture.

Spaciotemporal attributes 354 is a class of technical attributes that typically indicate the time and/or location of an image at image capture, such as (but not limited to):
Capture Time—generally refers to the time of image capture.
Capture Time Description—generally refers to a description of the capture time, such as “Morning”, “Lunch time”, “Tax day”, “Summer”, “Trash day”, “My birthday”, or any other description of the capture time.
Capture Location—generally indicates the location at the time of image capture; may be in to form of Global Positioning System (“GPS”) coordinates or the like.
Capture Location Description—generally refers to a description of the capture location, such as “Work”, “Home”, “Ball Park”, “Downtown Seattle”, or any other description of the capture location.

Adjacent attributes 355 is a class of technical attributes that typically indicate information obtained or derived from sources adjacent to an image and the system 200, such as (but not limited to):
Adjacent Information Sources—generally refers to any sources of information generally unrelated to or indirectly related to an image being processed by system 200.

As an example of an adjacent information source, the calendar of a person may indicate his son's birthday party at a particular time on a particular data and at a particular location. Accessing this information, and combining it with spaciotemporal attributes of a set of images, may enable deriving adjacent metadata indicating that the set of images are from the son's birthday party.

In general, any system or data source that can be accessed by system 200 may be an adjacent information source. Beyond calendars, further examples include social media applications, news sources, blogs, email, location tracking information, and any other source.

Adjacent attributes 355 may indicate a broad array of information about an image, such as social interest. The term “social Interest” as used herein refers to degree of interest shown by people, particularly in an image. In one example, a degree of social interest can be determined based on social media actions on the image, such as the number of times the image has been liked, favorited, reblogged, retweated, reshared, commented on, and the like.

Other adjacent attributes of an image may indicated information about the image, such as whether the image has been shared, by whom, and via what sharing mechanism(s); whether the image was edited, thus suggesting interest in the image; whether the image has been posted, by whom, any caption or comments on the posted image, etc.

Technical attributes related to face quality and face frequency may be based on facial recognition functionality configured for detecting faces and facial features in an image. Such functionality may be provided in technical attribute evaluator 230, image sensor 220, and/or some other module. In one example, such functionality is provided via a software development kit (“SDK”). One example of such facial recognition functionality is provided as system 200 described in U.S. patent application Ser. No. < > (Attorney Docket No. 321669.01), filed on < >, and entitled “RATING PHOTOS FOR TASKS BASED ON CONTENT AND ADJACENT SIGNALS”, that is incorporated herein by reference in its entirety.

In one example, facial recognition functionality detects any faces in an image and provides an identifier (e.g., a RECT data structure) that frames a detected face in the image. A distinct identifier is provided for each face detected in the image. The size of a face in the image may be indicated by its identifier. Thus, larger faces may be considered more dominate in the image than smaller faces.

Once a face is detected, facial recognition functionality detects various facial features. In one example, these features include various coordinates related to the eyes, the nose, the mouth, and the eye brows. Once the features of a face are detected, one or more face states may be determined.

Regarding the face as a whole, a pose of the face can be determined based on relative position of the eyes, node, mouth, eyebrows, and the size of the face. Such information can be used to determine if the face is in a relatively normal pose, in a forward-looking or other-direction-looking pose, or in some other pose.

Regarding an eye, the horizontal corners of the eye, as well as the eye lid and the bottom of the eye may be determined. From at least this information, the opened or closed state of the eye may be determined. Further, the eyeball location may be determined which, along with face pose information, can be used to determine whether or not the face is looking at the camera or at a subject of the image.

Regarding the mouth, a ratio between the horizontal mouth corner distance and the vertical Inner lip distance may be calculated. This ration, along with face pose information, may be used to determine if the mouth is in an open or closed state. Further, color information within the mouth area may be used to determine if teeth are visible. A sufficient indication of teeth, along with the relative position of the corners of the mouth can be used to determine if the mouth is in a smiling state.

The location of the face in the image may also be determined. For example, it may be determined if the face is located near or on an edge of the image, is cut off, or is located toward the center of the image. Such information may, for example, be used to determine a degree of conformance to the conventional “rule of thirds”, and also may be used to indicate a relative importance of the face.

Various facial expressions can be determined based on detected facial features and their various coordinates. In one example, these facial expressions include smiling, sad, neutral, and other. In addition, the detected facial features can be used to determine if the face is considered visually appealing based on various ratios among facial features that can be used to measure a degree of attractiveness.

Once a face and its features have been detected, the various details of the face and its features may be used to compute a signature for the face that, across the images in the set, uniquely identifies an entity that the face represents, at least within the scope of the detected features. For example, if various face shots of Adam appear in several images in a set, then each of Adam's face shots will have the same face signature that uniquely identifies the entity “Adam”, at least within the scope of the detected features. Such face signatures may be used to determine other faces in other images of the set 272 that represent the same entity, and thus may be used to determine a frequency that a particular entity appears in the image set 272.

FIG. 4 is a block diagram showing an example method 400 for selecting a representative subset of images from a set of images. In one example, the selecting is based on rating the images in the set based on task, image, and/or adjacent information.

Step 410 typically indicates system 200 receiving a set of images 272. In one example, the set of images is provided by a user. The received images may be stored in image database(s) 270.

Step 420 typically indicates system 200 receiving a query for a subset of images that is representative of the images in the set 272. In one example, the query is provided by a user that may be the same or different than the user that provided the set of images in step 410. The received query is typically provided to task evaluator 210 as input 212. The query indicates a request for a representative subset of images from the set of images 272 from the system 200. The query may be in the form of a request for a portion of the images that are representative of the set of images 272, may simply indicate a desired number of images that are representative of the set of images 272, may indicate an intended use for a representative subset of images from a set of images, or may otherwise indicate some form of task description. In one example, the query may include an indication of one or more technical attributes of interest by the user.

Step 430 typically indicates task evaluator 210 evaluating task or some other module information encompassed in the query received in step 420. This evaluating comprises parsing the query into a form that can be provided as output 214 to image selector 220.

Step 440 typically indicates image selector 220 or some other module determining groupings of images in the set 272. In one example, the evaluating comprises grouping images from the set 272 into clusters. Such grouping is known herein as “task-based grouping”, a term that generally refers to grouping images into clusters based on technical attributes of the images in the set 272 and/or those indicated by the evaluated task information 214. For example, perhaps the task is to present a slide show of family members in a set of images. In this example, images are grouped into clusters based on the family members dominate in the images, such as a group of images in which the son is dominant, another group in which the daughter is dominant, etc.

In another example, images may be grouped based on a clustering algorithm such as a k-means clustering algorithm. In this example, the clustering algorithm may find natural clusters based on technical attributes of the images in the set 272, and/or based on technical attributes indicated by the evaluated task information 214.

Step 450 typically indicates technical attribute evaluator 230 or some other module evaluating each image in the set 272 resulting in a set of technical attributes for the image. This step 450 can be performed at any time after a set of images is identified, but is generally performed prior to determining groupings such as in step 440 and selecting a representative subset such as in step 460. Most classes of technical attributes can typically be calculated once, such as classes 351-354. And then stored for future use. It may be desirable to calculate some classes of technical attributes, or specific technical attributes within a class, at the time a set of images 272 is being processed against a query. For example, various adjacent attributes in class 355 may depend on sources of adjacent information that can change at any time. For such attributes, it may be desirable to access the adjacent information and calculate the adjacent attributes using that information at the time a set of images 272 is being processed against a query. In general, the calculating of this step results in each of an image's technical attributes having a value or score that can be used in calculating the image's overall quality score. Further, each technical attribute's value may be weighted as described in the following paragraph. Thus, the terms “technical attribute value” and “weighted technical attribute value” are used herein are used synonymously unless indicated otherwise.

In one example, each technical attribute of an image may be assigned a weight that establishes the importance of that attribute in an overall quality score of the image. For example, a heavily-weighted attribute may contribute significantly to an images quality score, while a lightly-weighted attribute may have very little, if any, impact on the image's quality score. In another example, the weight of an attribute may be set to have no effect on the calculated value of the attribute.

Step 450 also typically indicates technical attribute evaluator 230 or some other module calculating a quality score for each image in the set 272 based on the values of its technical attributes. In one example, an image's quality score may be calculated as a sum or product of the values of its technical attributes. In another example, a score for each class of technical attributes may first be calculated, each based on the same or a different computational method, and then an image's overall quality score may be calculated based on the class scores using any desired computational method. In on example, the values of technical attributes are each calculated to be a number between zero and one, as are the quality scores of images. The quality score of each image in the set 272 essentially indicates a rating of the image. That is, images in the set 272 with better quality scores are essentially rated as more representative of the set 272 than images with worse quality scores.

Step 460 typically indicates image selector 220 or some other module selecting a representative subset of images from the set of images 272. In one example, task information provided by the task evaluator 210 is used to indicate a total number of images to be placed in the subset. If the images in the set 272 are grouped into more than one cluster, the total number of images may be divided among the clusters. Thus, in the case of one cluster, the cluster number equals the total number, and in the case of multiple clusters, the sum of cluster numbers equals the total number.

Continuing the example, for each cluster of images in the set 272, image selector 220 selects the cluster number of images from the cluster, typically selecting the images in the cluster with the best quality scores. Once the total number of images has been selected from the clusters, the selected images are typically provided 222 as the representative subset of the set of images 272.

In view of the many possible embodiments to which the invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

1. A method performed on a computing device, the method comprising: selecting, by the computing device, a representative subset of images from a set of images, where the selecting is based on task information and is further based on a quality score for each image in the set.

2. The method of claim 1 where the quality score for the each image is based on at least a portion of technical attributes of the each image.

3. The method of claim 2 where the technical attributes include at least one adjacent attribute, at least one face quality attribute, at least one face frequency attribute, or at least one relationship attribute.

4. The method of claim 3 where the at least one face quality attribute is calculated based on detected facial features of a face detected in the each image.

5. The method of claim 1 where the set of images is grouped into one or more clusters based on the task information.

6. The method of claim 5 where the representative subset includes at least one image from each of the one or more clusters of the set.

7. The method of claim 1 where a total number of images in the representative subset is based on the task information.

8. A system comprising a computing device and at least one program module that are together configured for performing actions comprising: selecting a representative subset of images from a set of images, where the selecting is based on task information and is further based on a quality score for each image in the set.

9. The system of claim 8 where the quality score for the each image is based on at least a portion of technical attributes of the each image.

10. The system of claim 9 where the technical attributes include at least one adjacent attribute, at least one face quality attribute, at least one face frequency attribute, or at least one relationship attribute.

11. The system of claim 10 where the at least one face quality attribute is calculated based on detected facial features of a face detected in the each image.

12. The system of claim 8 where the set of images is grouped into one or more clusters based on the task information.

13. The system of claim 12 where the representative subset includes at least one image from each of the one or more clusters of the set.

14. The system of claim 8 where a total number of images in the representative subset is based on the task information.

15. At least one computer-readable media storing computer-executable instructions that, when executed by a computing device, cause the computing device to perform actions comprising: selecting, by the computing device, a representative subset of images from a set of images, where the selecting is based on task information and is further based on a quality score for each image in the set.

16. The at least one computer-readable media of claim 15 where the quality score for the each image is based on at least a portion of technical attributes of the each image.

17. The at least one computer-readable media of claim 16 where the technical attributes include at least one adjacent attribute, at least one face quality attribute, at least one face frequency attribute, or at least one relationship attribute.

18. The at least one computer-readable media of claim 17 where the at least one face quality attribute is calculated based on detected facial features of a face detected in the each image.

19. The at least one computer-readable media of claim 15 where the set of images is grouped into one or more clusters based on the task information, or where a total number of images in the representative subset is based on the task information.

20. The at least one computer-readable media of claim 19 where the representative subset includes at least one image from each of the one or more clusters of the set.
